(19) United States
(12) Patent Application Publication
(10) Pub. No.: US 2002/0171625 A1
(43) Pub. Date: Nov. 21, 2002

(54) Pistol-grip trackball mouse

(75) Inventor: Ronald Rothchild, Farmingdale, NY (US)

Correspondence Address: Ronald Rothchild, 140 Marine Street, Farmingdale, NY, 11735, US

(73) Assignee: Jona Group, Ltd., Farmingdale, NY

(21) Appl. No.: 10/143,737

(22) Filed: May 10, 2002

Related U.S. Application Data
(60) Provisional application No. 60/291,524, filed on May 15, 2001.
(60) Provisional application No. 60/311,878, filed on Aug. 13, 2001.

(51) Int. Cl. G09G 5/00

(52) U.S. Cl. 345/156

(57) ABSTRACT

A computer input device, comprising a pistol grip handle and having the functionality of a conventional computer mouse. In the preferred mode, the invention is hand-held and comprises a pistol grip with front and rear edges, left and right edges, and a top end and butt end. A thumb-operated control is located upon at least one side of the grip, in a position suitable to allow the user's thumb to engage same easily when the pistol grip is normally held. A plurality of buttons to emulate functions of conventional computer mouse buttons, such as a first button on an upper portion of the grip front edge, and a second button at a lower position upon the front edge. A third button may be included at a lower position, and each button allows the user to depress the same in a trigger-like fashion. Moreover, the device provides a latching function to allow a user to perform click and drag type functions. Such generates a continuous signal, as if a button were being depressed and held in position. Thus, the hand-held input device allows for usage with reduced desk space and the device may be easily used in moving vehicles. Enhanced embodiments of the device include a version worn on the user's hand, and the device may be cordless and further comprises a data link transmitter which may be upon an upper surface thereof. Such embodiment is sufficiently compact to allow a user to operate a computer keyboard while the input device is held in place via restraint means.

This application relates to material disclosed in application No. 60/291,524 filed May 15, 2001, and in application No. 60/311,878 filed Aug. 13, 2001, by the present Applicant.

### BACKGROUND OF THE INVENTION

1. Field of the Invention

The present invention generally relates to a hand-held computer interface device with a pistol-grip handle, which has the functionality of a conventional “mouse.” In the preferred mode, the device comprises a pistol grip with front and rear edges, left and right edges, a top end and butt end, with a track ball located upon at least one side of the grip in a position suitable to allow the user's thumb to engage the sane. The device further comprises a plurality of buttons to emulate the functions of conventional computer mouse buttons, such as a first button on an upper portion of the grip front edge, and a second button at a lower position upon the front edge. A third button may be included at a lower position, and each button allows the user to depress the same in a trigger-like fashion. Moreover, the device provides a latching function to allow a user to perform click and drag type functions, in which a continuous signal is generated, as if a button were depressed and held in position.

Enhanced embodiments of the device include a version worn on the hand rather than held. In such case, the input device may comprise a data link transmitter upon an upper surface, creating an embodiment sufficiently compact to allow a user to operate a computer keyboard with the device held in place via restraining means. All of the foregoing is achieved in an ergonomic manner, as the present invention allows for a grip that may be used comfortably for extended periods of time, for left-handed or for right-handed users.

2. Description of the Prior Art

Numerous innovations for computer input devices have been provided in the prior art that are described as follows. Even though these innovations may be suitable for the specific individual purposes to which they address, they differ from the present invention as hereinafter contrasted. The following is a summary of those prior art patents most relevant to the invention at hand, as well a description outlining the differences between the features of the present invention and those of the prior art.

1. U.S. Pat. No. 5,506,605, invented by Paley, entitled “Three-Dimensional Mouse With Tactile Feedback”

In the patent to Paley, a three-dimensional mouse is disclosed for interfacing with a central processing unit. The mouse comprises a hand-held housing adapted to be used in free space. The housing has a generally vertical orientation relative to the user. A mechanism, mounted in the housing, is provided for locating the mouse with respect to at least one of spatial dimension and orientational dimension, which locating mechanism includes a mechanism for transmitting the location to a central processing unit.

2. U.S. Pat. No. 5,296,871, invented by Paley, entitled “Three-Dimensional Mouse With Tactile Feedback”

In this patent to Paley, (previous application) also disclosed is a three-dimensional mouse for interfacing with a central processing unit. The mouse comprises a hand-held housing adapted to be used in free space. The housing has a generally vertical orientation relative to the user. A mechanism, mounted in the housing, is provided for locating the mouse with respect to at least one of spatial dimension and orientational dimension, which locating mechanism includes a mechanism for transmitting the location to a central processing unit.

3. U.S. Pat. No. 5,982,356, invented by Akiyama, entitled “Ergonomic Computer Cursor Control Apparatus And Mount”

The Akiyama invention describes a hand-held, ergonomically-configured apparatus for manipulating an electronic control signal in a computer, where a mounting element supports an upright support element operably secured to the mounting element and a wrist support for supporting a wrist is positioned on the mounting element. The wrist support is configured to conform to a human wrist for support and comfort. An elongated element adapted for grasping by hand includes a top horizontal surface, a bottom surface, a front wall, a rear wall, an outwardly curved rear surface, and a front surface having a curved grip adapted to be held by a human hand. The elongated element has an aperture on the bottom surface adapted for securing the upright support element therein and a pair of input control buttons are positioned on the front wall and mounted in relation to the curved grip of the front surface so as to allow operation of the pair of input control buttons by an index finger tip and a middle finger tip. A joystick is mounted on the top horizontal surface of the elongated element for controlling a moveable graphic element on a display screen of a computer corresponding to movement or orientation of the joystick in an x-dimension, a y-dimension, and a z-dimension.

4. U.S. Pat. No. 5,670,988, invented by Tickle, entitled “Trigger Operated Electronic Device”

The patent to Tickle describes a device, particularly for use with a computer, comprising a housing for location at least partly between two fingers of a user's hand and an electronic circuit mounted on a board within the housing. The circuit includes a switch responsive to pressure selectively to open and close an electronic circuit, and conductive elements arranged on the board mounting the electronic circuit. A first control element is mounted with the housing and responsive to finger pressure such that pressure applied to the first control element causes the element to operate the switch. The first control element is movable with respect to a hinge such that finger action acts to cause the control element to swivel as a trigger about the hinge and thereby interact with the switch. The second control element includes a flexible material mounted such that pressure applied to the flexible material in different directions and positions acts to change the electrical relationship between the conductive elements on the board and thereby vary an output signal from the electronic circuit. The rear portion of the housing includes a receptacle for receiving removable battery power supply for powering the electronic circuit. There is an infra-red output signal transmitted to a receiver for operating the computer. The first control element is located substantially below the second control element, and the first control element being in a bottom face of the housing.

5. U.S. Pat. No. 4,739,128, invented by Grisham, entitled “Thumb-Controlled, Hand-Held Joystick”

The patent to Grisham describes a manipulandum contained in a portable housing unit adapted for grasping by hand and situated at one end thereof within an area reachable by the thumb without rearranging the grasp. In one preferred embodiment, the manipulandum is a joystick extending a short distance from the surface of the housing, with its center of neutral position being essentially perpendicular to the center line of the elongated segment in the neighborhood of the joystick. The joystick has a fixed number of positions, with each position being contained within a preselected solid angle. An additional control dimension is realized by moving the joystick along its axis, against a resilient spring, so as to activate or make contact with an electrical switch.

6. U.S. Pat. No. 6,262,715, invented by Sawyer, entitled “Ergonomic Computer Mouse”

In the patent to Sawyer, an improved ergonomic computer mouse provides comfortable and efficient usage by maintaining the hand of a user at a large acute angle to the horizontal. This is accomplished by a device that includes a base having an upstanding pedestal structure about which the palm and hands of the user extends in a more natural handshake manner at a large acute angle to the horizontal whereby the users wrist remains straight while grasping the mouse. Control means in the base and upstanding structure within easy reach of the users fingers allow the user to efficiently and comfortably control the computer operations. Indentations and an enlarged upper head portion provide for comfortable grasping and easy lifting of the mouse. The pedestal may be rotated 180 degrees to accommodate both right and left handed use. Add-on OEM, and custom fitted embodiments are also disclosed.

7. U.S. Pat. No. 4,425,488, invented by Moskin et. al, entitled “Pistol Grip Controller”

In the patent to Moskin et al., a pistol grip controller having a miniature multi-position tilt switch contained within the grip handle is disclosed. The tilt switch includes separate circuit contacts disposed about the inside of a switch housing and also includes a common contact that includes one or more commonly connected contact elements. A movable contact element completes the circuit connection between one of the separate contacts and the common contact in response to the movement imparted to the switch. The movable conductive element can be a conductively plated ball, a sliding conductive element, or a conductive fluid such as mercury. The pistol grip handle further indicates an index finger actuated switch and a thumb actuated switch. The pistol grip handle is removable mounted on a resilient mounting post that is secured to a base.

8. U.S. Pat. No. 5,175,534, invented by Thatcher, entitled “Computer Input Device Using The Movements Of A User's Fingers”

In the patent to Thatcher, disclosed is an input device for a computing machine which allows a user to input one, two, three, or more position signals controlling the same number of parameters. Such parameters can be the x, y, and z axis positions of a cursor on a display. The Thatcher invention includes structures for encoding the movement of the users fingers into position signals. The present invention is arranged so the differential movement of two of the user's fingers in a first plane generates one of the position signals. The differential movement provides that as a first finger is moved, a second finger is moved in an opposite direction and an amount proportional to the movement of the first finger. The differential movement of the user's fingers allows for more efficient, precise, and less tiresome operation by a user than with other input devices. Embodiments of the present invention can possess movement in one, two, three, or more, degrees of freedom and are able to generate one, two three, or more, position signals. In a preferred application of the present invention, apparatus embodying the present invention possessing three degrees of motion can be adapted to interactively control a cursor's horizontal, vertical and zoom movements on the x, y, and z axes, respectively, on a computing machine display.

9. U.S. Pat. No. 6,130,664, invented by Suzuki, entitled “Input Device”

The Suzuki invention describes an input device, not requiring a flat operating surface, easy to operate, and capable of being used with a feeling more accurately matching the human sense. The input device indicated at 1 comprises a case having a bottom a bottom surface having the shape of a cubic curve, two angular velocity sensors housed within the case, a signal processing section for converting sensor output into control signals, and selecting switches. The first angular velocity sensor, whose central axis is fixed along Z axis, detects rotation in a horizontal plane of the input device. The second angular velocity sensor, whose central axis is fixed along X axis, detects rotation in a vertical plane in the longitudinal direction of the input device.

10. U.S. Pat. Des. No. 430,161, invented by Hovsepian, entitled “Hand Supported And Controlled Mouse”

The patent to Hovsepian depicts an ornamental design for a hand supported and controlled mouse, as shown and described.

11. U.S. Design Pat. Des. No. 347,833, invented by Bisenius et al., entitled “Computer Mouse”

The patent to Bisenius depicts an ornamental design for another computer mouse.

Generally, the prior art patents illustrate various alternatives to conventional input devices, including: vertically oriented input devices affixed to horizontal bases; upright input devices in combination with particular mounting structures therefor, and various hand-held input devices of non-pistol grip configuration. It should be noted that several pistol grip handles found in the prior art relate only to particular joysticks or game devices.

In contrast to all of the above, the present invention comprises a pistol grip handle with the particular functionality of a conventional computer mouse. In the preferred mode, the hand-held device comprises a track ball engaged by a user's thumb and a plurality of buttons to emulate functions of mouse buttons, engaged by the fingers in a trigger-like manner. A latching function, engaged via software or hardware means, generates a continuous signal to allow the user to perform click and drag functions. Importantly, the invention may be used with little desk space or even in moving vehicles. In addition, this embodiment provides fine control in an ergonomic manner that is easy for users to adopt. Moreover, no above-referenced patent discloses an input device worn on the user's hand, which allows a user to operate a keyboard while the device is held via restraint means.

### SUMMARY OF THE INVENTION

As noted, the present invention is a computer interface device, comprising a pistol grip type handle, and having the functionality of a conventional computer mouse. In the preferred mode, the invention is hand-held and comprises a pistol grip with front and rear edges, left and right edges, and top and bottom surfaces. Preferably a track ball or slide control is located upon at least one side of the grip, in a position where the user's thumb naturally rests when gripping the device in the manner of a normal pistol-grip, allowing the thumb to engage the track ball naturally, and this track ball or slide control is preferably the means for exercising control of cursor position. The device further comprises a plurality of buttons to emulate the functions of conventional computer mouse buttons, such as a first button on an upper portion of the grip front edge, and a second button at a lower position upon the front edge. A third button may be included at a lower position, and each button allows the user to depress the same in a trigger-like fashion.

Moreover, the device provides a latching function to allow a user to perform click and drag type functions. Such generates a continuous signal, as if a button were being depressed and held in position. The latching function may be engaged via software means in response to an input action, or via hardware means, such as an additional button or switch at an appropriate pre-determined location.

Unlike prior art mouse devices which require very specific operating conditions in order to function effectively, the hand-held input device of the present invention allows for usage with considerably less desk or surface space. Moreover, due to its hand-held configuration, the preferred mode of the invention is easy to use in moving vehicles and under a host of other non-conventional circumstances. It should further be noted that the invention provides a computer input device with fine control—an element often lacking in the “alternative” input devices of the prior art.

Furthermore, enhanced embodiments of the pistol-grip mouse include a version that is worn on the user's hand rather than held. In such an instance, the input device may comprise a data link transmitter upon an upper surface thereon. Importantly, this embodiment is sufficiently compact to allow a user to effectively operate a traditional computer keyboard, while the input device is held in place via strap or alternate restraining means.

Importantly, all of the foregoing is achieved in an ergonomic manner, as the present invention allows for a grip that may be used comfortably for extended periods of time, for left-handed or for right-handed users. Thus, in total, the present invention effectively addresses a variety of deficiencies in the prior art, and does so in a manner that is easy for users to learn and adopt.

In light of the foregoing, it is generally an object of the present invention to provide a computer input device with mouse functionality that offers significant inertial stability, responding only minimally to inadvertent motions of a user's arm such as may be imposed by erratic vehicle motion.

It is an additional object of the invention to provide a device with fine controllability, for precision usage.

In addition, it is an object of the invention to provide a device that produces low physiological stress to the user.

Another general object of the invention is to provide a device that offers a high degree of comfort for the user.

It is also an object of the invention to provide a device that is easy for the user to put down and pick up quickly, or that alternatively can be held without interfering with keyboard use.

It is a further object of the invention to provide a device that is comfortable to hold and use, with the user's fingers stabilized and supported by the grip.

It is a further object of the present invention to provide a device that may be cordless in nature, utilizing data links such as IR, which requires line-of-sight transmission, or RF to avoid a line-of-sight requirement for effectiveness.

It is an additional object of the present invention to provide a device that allows for effective cursor control absent the usage of a desk-supported mouse or traditional input device.

In addition, it is an object of the present invention to provide a device that may be produced in a variety of sizes.

Furthermore, it is an object of the present invention to provide a device that is easy and comfortable to operate, even without the user making visual contact with the device while using the same.

Finally, it is an object of the present invention to provide an input device that allows the user to quickly utilize a keyboard without putting the input device down.

The novel features which are considered characteristic for the invention are set forth in the claims. The invention itself, both as to its construction and its method of operation, together with additional objects and advantages thereof will be best understood from the following description of the embodiments when read and understood in connection with accompanying drawings.

### BRIEF DESCRIPTION OF PREFERRED EMBODIMENTS

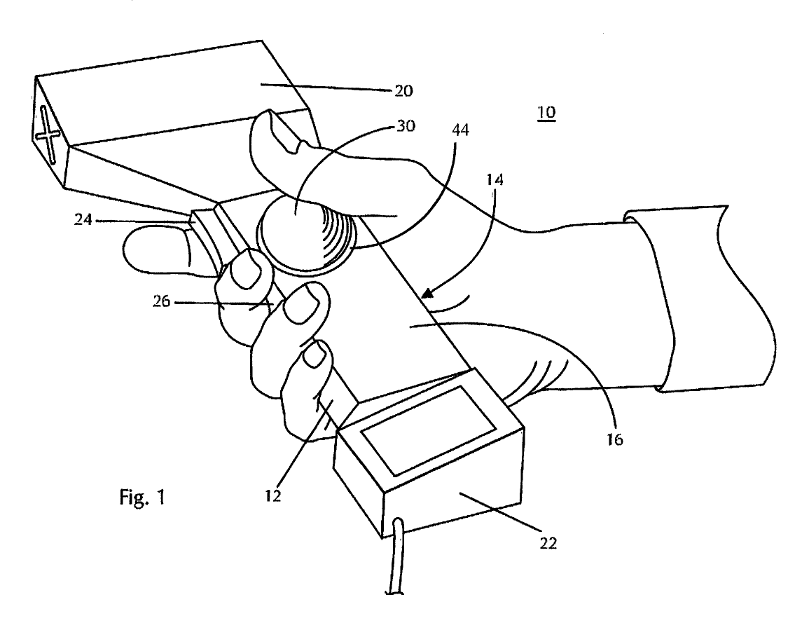

FIG. 1 is a left side, three-quarter perspective view of the preferred mode of the pistol-grip trackball mouse, shown held in the right hand of the user for the purposes of example only.

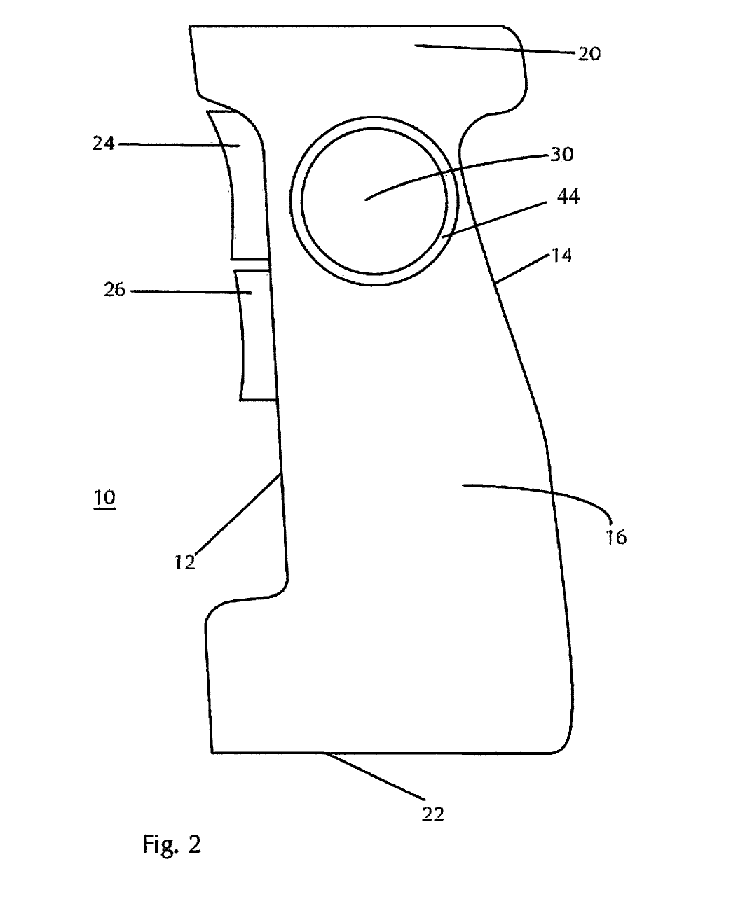

FIG. 2 is a left side view of the pistol-grip trackball mouse, illustrating the location of the trackball and first and second trigger buttons in the preferred mode.

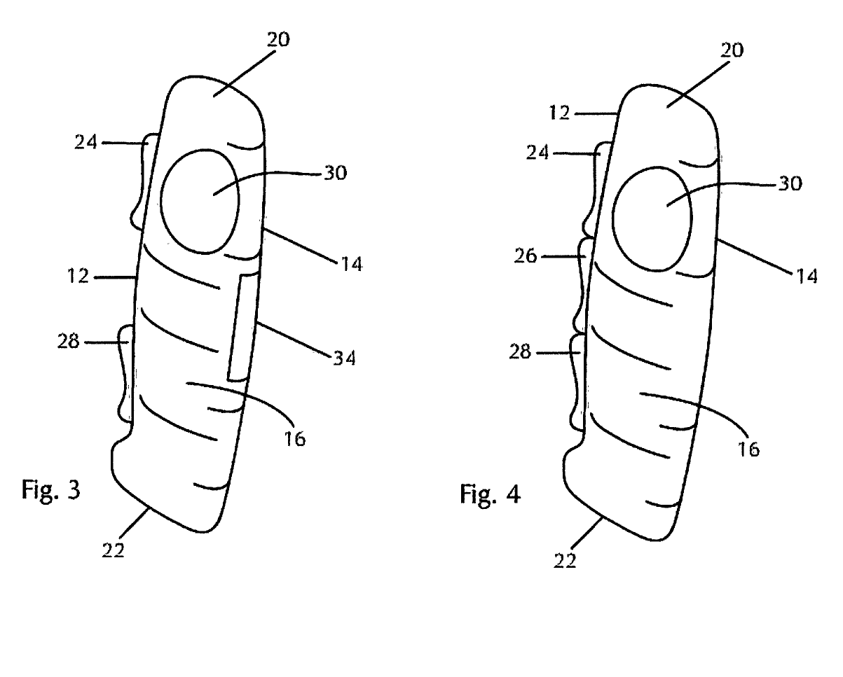

FIG. 3 is a side, three-quarter perspective view of the pistol-grip trackball mouse, illustrating the spacing of first and second trigger buttons in one mode of production, as well as a third trigger button upon the rear edge of the grip.

FIG. 4 is a side, three-quarter perspective view of the pistol-grip trackball mouse, illustrating first, second, and third trigger buttons upon the front edge of the grip, for the purposes of example only.

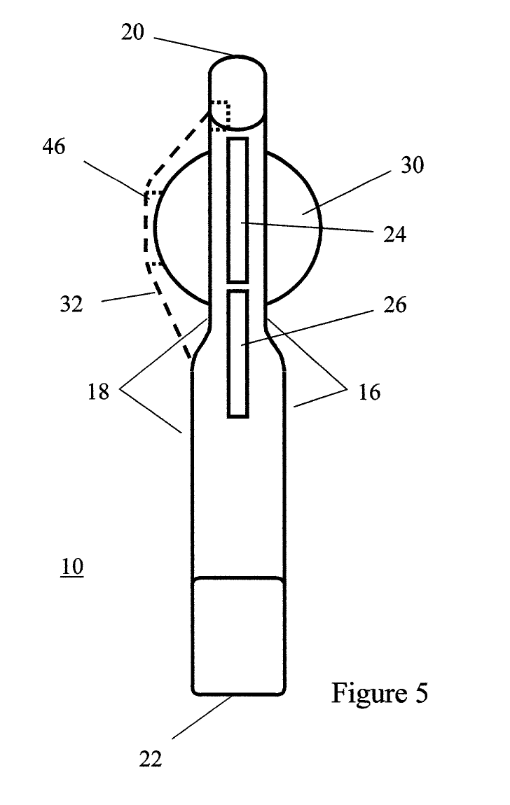

FIG. 5 is a front view of the pistol-grip trackball mouse, illustrating the general proportions of the principal components thereof, as well as a trackball cover utilized in alternate modes of production.

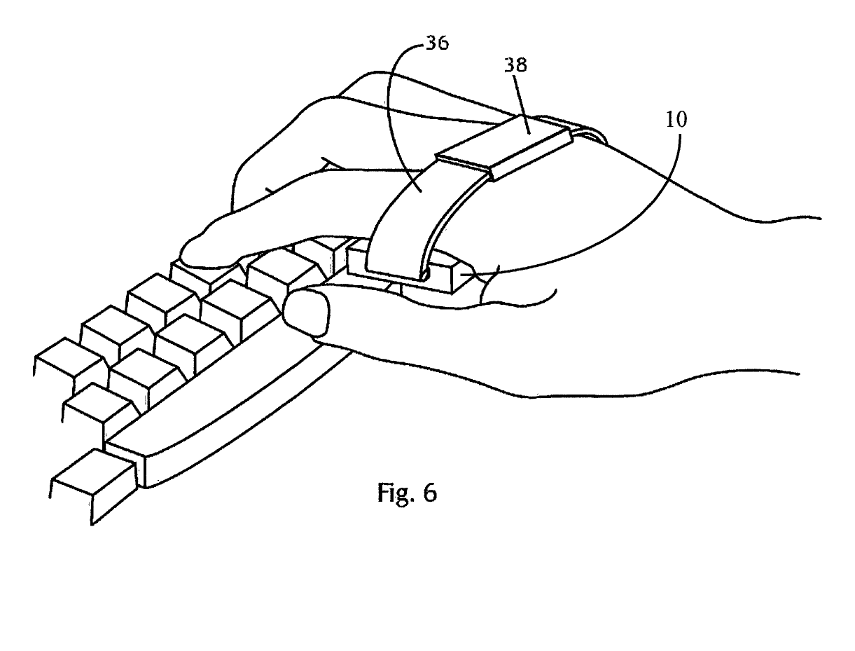

FIG. 6 is a left side, three-quarter perspective view of the glove mouse mode of the present invention, shown worn on the right hand of the user during usage of a computer keyboard, and illustrating a module upon the back of the restraint means for the purposes of example.

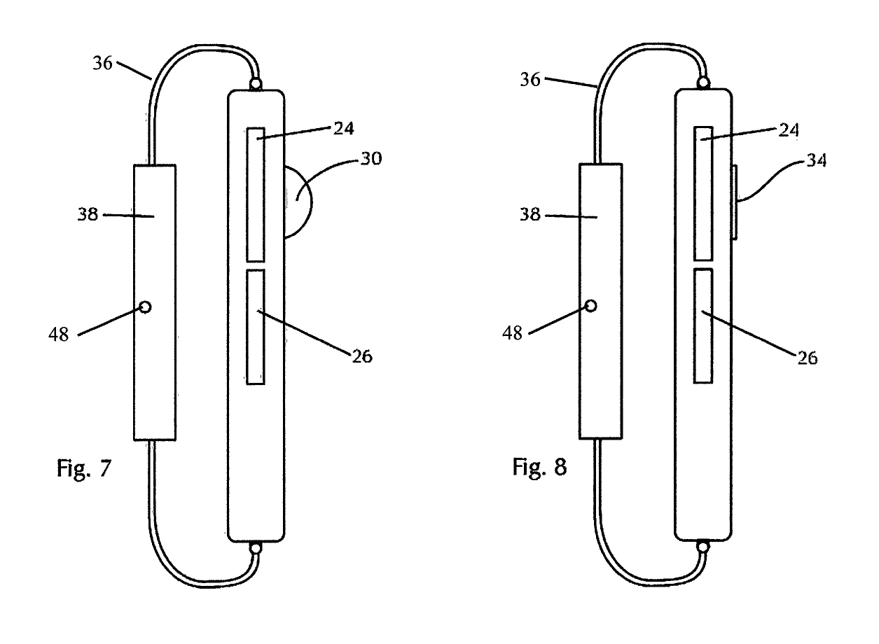

FIG. 7 is a side view of the glove mouse, including a trackball that is engaged by the thumb of the user, and forward facing IR data-link within the module to be located upon the back of the hand.

FIG. 8 is a side view of the glove mouse, including thumb-operated slide control means that is engaged by the thumb of the user, as an alternate to the embodiment illustrated in FIG. 7.

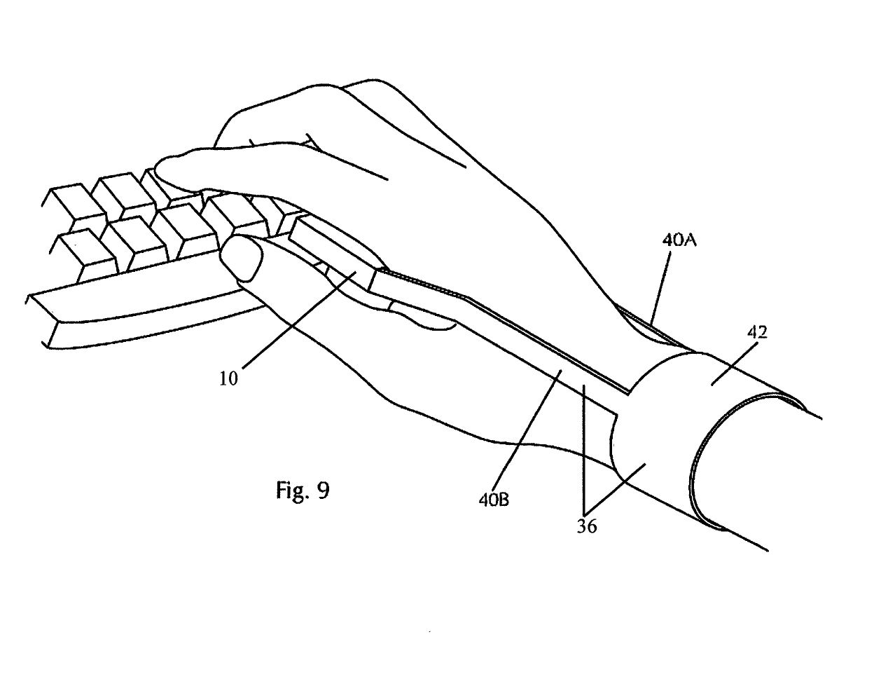

FIG. 9 is a left side, three-quarter perspective view of the glove mouse in an alternate mode of the invention, shown worn on the right hand of the user during usage of a computer keyboard, and further illustrating restraint means side support members for the purposes of example.

### DETAILED DESCRIPTION OF THE PREFERRED EMBODIMENT

Generally, the hand-held pistol-grip input device (10) for usage in conjunction with a computer system comprises a pistol grip handle, which comprises a forward surface (12), rear surface (14), left side (16), top end (20), and butt end (22), all of which are depicted in FIG. 1. The grip further comprises right side (18) which is not visible in FIG. 1 but can be seen in FIG. 5. A previously-determined thumb-operated cursor control means is preferably located upon a side surface of the input device, the cursor control means functioning to allow a thumb of an operator to rest naturally thereon as the pistol-grip input device is hand-held by the user.

In the preferred mode, the cursor control mechanism is a trackball (30) that protrudes from either the left side of the grip (16) as shown in FIGS. 1 and 2, left side (16), or both sides of the grip (16, 18), as shown in FIG. 5 and discussed in greater detail herein. The trackball (30) is located in a position where the user's thumb would rest when the grip is held in its intended fashion, and moving of the trackball (30) allows for control of the computer cursor in the ordinary fashion.

The invention comprises a plurality of previously-determined buttons that emulate the respective functions of buttons found on a conventional computer mouse. In the preferred mode, the plurality of buttons are in the form of triggers located upon the grip's front edge (12), at a location where the user's fingers wrap around such front edge when the grip is held in the ordinary fashion, as indicated by FIG. 1.

For example, a first button (24) functions as a first trigger engaged by an index finger of the user and a second button (26) functions as a second trigger engaged by a middle finger of the user. More particularly, in the preferred mode, the first button (24) is located high on the front edge (12), in the location similar to that of a trigger on a conventional pistol, where the user's index finger wraps around the front edge (12) when the grip is held in its intended manner. The first button (24) is therefore positioned to be easily depressed by the index finger, in the manner of a trigger, as depicted in FIG. 1. It is preferred that the first button (24) emulate the function of the left button on a conventional computer mouse, with selection or identification functions.

In the preferred mode, the aforementioned second button (26) is located below the first trigger or button (24) but in close proximity thereto, where the user's additional fingers wrap around the front edge (12) when the grip is held in its intended manner. The second button (26) is therefore positioned to be easily depressed by the middle, also in the manner of a trigger, as also depicted in FIG. 1.

Like the first button (24), the second button (26) is elongated in the form of a trigger, but functions as a center trigger. It is preferred that the second button (26) emulate the function of the right button on a conventional computer mouse, with a variety of functions that correlate to particular operating systems and software programs utilized.

As an alternative to the above, the second button (26) may be lower on the front edge (12) of the grip, as illustrated in FIG. 3, in which case the second button (26) is still elongated in the form of a trigger. In this mode, the lower trigger (26) is positioned to be easily engaged by one or both of the user's ring and little fingers, where the same wrap around the front edge (12) of the grip when the device (10) is held in the usual manner. In the embodiment depicted by FIG. 3, the lower trigger (26) emulates the function of the right button on a conventional computer mouse, much in the manner noted above.

Regarding the versatility of the concept of the present invention, for the purpose of additional functionality, the embodiment depicted in FIG. 3 also comprises a third button (28) on the rear edge (14) of the grip. The third button (28) may be located above the lower trigger (26) and below the first trigger (24) as shown in FIG. 3. Preferably, the third button (28) is substantially flush with the surface of the rear edge of the grip (14), much like safety mechanisms upon common pistols such as the M1911 Colt .45 semi automatic.

Thus, in this embodiment, the third button (28) is specially positioned to be engaged by the heel of the user's hand, with appropriate pressure corresponding to a pressure with which the user is grasping the pistol-grip device (10). Such pressure sensor means, and a specific alternative thereto, is discussed in greater detail herein.

As an alternate to the configuration described immediately above, the third button (28) may functions as a center button on the front edge of the grip (12), thus functioning as a center trigger, as illustrated in FIG. 4. Such provides additional versatility of design, offering another configuration for user convenience.

In any such mode of manufacture, the device further comprises a previously-determined latching means such that, when engaged by the user, the device produces a signal corresponding to a left mouse button in depressed position, even while a corresponding button is not necessarily held down by the user. Absent such a latching means, in order to emulate the click-and-drag function of a conventional mouse, the user would be forced to hold down one of the buttons, while moving the trackball or other cursor control means with the thumb. Such is considered awkward in nature, as well as reducing the accuracy of the intended drag motion.

Thus, the aforementioned latching function may be provided to generate a continuous signal, internal to the device, as if the button emulating the left mouse button was being continuously depressed. Such allows the user to be free to move the cursor control mechanism as required, to drag an object on a computer monitor without simultaneously holding any button down.

Such latching function may be initiated by known software means in response to a specific device input action by the user, that the software is programmed to associate with latching. As an example of same, the input device logic may be arranged to initiate latching when the user simultaneously depresses both the first button and second button, which are not depressed simultaneously during ordinary operations.

Furthermore, the latching function may be alternatively initiated by hardware means, such as an additional switch or button upon the butt end of the device (22). In this location, the latching actuator may be engaged, for example, by the operator pressing the butt end (22) against a desk or other convenient surface, or even against his or her leg. The latching switch may terminate and/or initiate the latching function, such as with a push-to-open and push-to-close action.

In another alternative, the latching function may be terminated without return to the latching switch, such as by the user depressing another button located on the device to interrupt latching. Such an embodiment may utilize known software means to detect and interpret such interruption.

Next, the device of the present invention further comprises a thumb control, which is preferably within a reversible cartridge such that the device can be held and operated in a right hand or a left hand of the user, with the thumb control on the left side or the right side of the device. Thus, whether a trackball (30), as depicted in the first four FIGURES, or thumb-operated slide control (34), as depicted in FIG. 8, is used, it may be within a removable and reversible cartridge, such that the ICM can adapt to both right-handed and left-handed users. FIGS. 7 and 8 illustrate such cartridge in position for a right-handed user, such that the trackball (30) or slide control (34) is exposed on the left side of the grip (16).

The cartridge may be reversed by removing same from an opening in the grip that comprises a means to accommodate the same. Further, the user may push it in the opposite side, such that the trackball (30) or slide control (34) is then exposed on the right side of the grip (18) for usage by left-handed persons, for the purposes of example.

In such an instance, the top or uppermost portion of the cartridge remains on top, but the portion that was previously toward the front of the grip is then oriented toward the rear thereof. It is important to note, then, that no change in programming is needed to accommodate usage with different hands when the conversion is made with the cartridge in manner described above.

When the cursor control means is a thumb-operated trackball (30), the trackball (30) is relatively small and compact in nature, such as not exceeding 2 inches in diameter in the preferred mode. More specifically, in the preferred mode the trackball (30) is also at least 1 inch in diameter. It is considered preferable that the trackball (30) protrude from either side of the grip (16 or 18) by a distance of at least approximately 25% of the diameter of the trackball (30), as illustrated in FIG. 5. In such case, a rearmost exposed surface of the trackball (30) is preferably not more than ⅛ inch forward of the rear surface of the grip (14) at the closest point thereof, as best illustrated in FIG. 2.

Moreover, as also shown in FIG. 5, the trackball (30) may protrude from both left side (16) and right side (18) of the grip, functioning to allow both left-handed and right-handed users to effectively operate the input device. It is important to note that the device may comprise a means to reverse a direction of motion with which the cursor responds to trackball rotation, functioning to allow for such usage by left-handed and right-handed users.

In addition, the device may comprise a detachable cover (32) which functions to cover the trackball (30) on a side of the grip (16 or 18) that is not functional, thus allowing the trackball (30) to be exposed to the thumb of the user on only the side of the grip corresponding to the right-handed or left-handed orientation of the user (16 or 18). Importantly, the trackball cover (32) is contoured to be comfortable against the operator's palm.

As noted above, FIG. 5 shows an embodiment in which the trackball (30) protrudes from both the left side and right side surfaces (16 and 18). The at least one detachable cover (32) is depicted by the dotted line in FIG. 5, provided to cover the trackball (30) on the side of the hand-mouse where the trackball is not intended to be accessible.

In the preferred mode, the device further includes hardware means to adjust the sign of internal calculations that determine cursor motion based on trackball rotation. This functions to allow both left handed and right handed operators to use the hand-mouse in the same intuitive way, with apparent thumb motion corresponding to cursor motion accordingly. The hardware means may conveniently be a switch. The switch's function is to reverse the directional relationship, between the component of trackball rotation about a vertical axis and the horizontal cursor motion that results from such rotation. this may be a manually operated switch at any location upon the device that is convenient for the user. However, it is preferred that the sign be changed by at least one automatically-operated switch or sensor means, located at a point of attachment of the trackball cover (32). Such sensor may be actuated by and automatically respond to the cover attachment placed over one side of the trackball (30), providing the utmost of convenience to the user.

Regarding enhanced embodiments, the cursor control of choice may be frictionally constrained such that a threshold force is required for the user to move the thumb control and most effectively move a cursor controlled thereby. For the purposes of example, when the thumb control is a trackball (30), the frictional constraint to rotation may be imposed by a sliding lip seal (44) that also serves to wipe the same of contaminants, best depicted in FIGS. 1 and 2. In such instance, the threshold force required to move the thumb control may be substantially the same as a force required to continue motion thereof, once again for the purpose of user convenience.

In addition, the thumb control and grip itself may be so disposed that when the device is held between the thumb and palm of the user, the thumb control may be operated over a full range of motion while the thumb is held in a substantially straight position, as demonstrated by FIG. 1. Thus, in the instance of trackball (30) usage, this full range of its motion is; in the up and down direction, limited by the thumb coming in contact with the appropriate side of the grip (16 or 18). Similarly, in the front and back direction, the range of motion is limited by reaching the tip or base of the thumb during typical rolling action against the trackball (30).

In one embodiment of the present invention the device includes a pressure sensor means which functions to monitor thumb pressure on the preferred thumb control and produce a signal used to modify a proportional relationship between thumb control motion and resulting cursor motion. Specifically, this mechanism functions to change the relationship between thumb control motion and resulting cursor motion, such that an increase in applied pressure will result in a given thumb control motion yielding a smaller cursor motion.

This electrical force sensor that yields a signal that varies in correspondence with the level of applied force allows a very small motion of the trackball, in the presence of only very light grip pressure, to move the cursor a substantial distance when moving it in a gross motion across the screen. As an example of the above, a ⅛″ thumb motion may move the cursor across the monitor screen entirely. in contrast, a conventional computer mouse must be rolled about 1½″ to accomplish the same task.

Alternatively when the cursor is already near an icon or the like and the user wants to target the same with a precise cursor motion, the user “bears down” on the grip. In this instance, the same trackball motion moves the cursor only a relatively small distance, with significant precision. For example, in the presence of applied pressure, the same ⅛ inch thumb motion may produce only about ⅛ inch of cursor motion for the purposes of precise cursor placement. In this manner, the natural tendency to bear down harder when seeking precision is efficiently utilized to provide the degree of precision required for the task at hand.

Furthermore, the force sensor may be located at any point where a force corresponding to gripping force would ordinarily be applied on the input device. However, in the preferred mode, the force sensor is located in a position best served to sense the force of the thumb bearing down upon the trackball (30). Regarding same, FIG. 5 shows the force sensor (46) located on the inside of the trackball cover (32) in a location where it is naturally subject to compression from force applied by the thumb on the opposite side of the device. In this location, with the trackball (30) and force sensor in sliding contact when the trackball (30) rotates, the force sensor is also used to provide optimal frictional resistance to rotation.

As an alternative to the mechanism described above, the cursor control may be a thumb-operated slide control mechanism (34), as in FIG. 8, that is captive on a side of the grip (16 or 18), the slide mechanism (34) functioning to slide up and down and forward and backward with respect to the grip. Thus, a captive 2-dimensional slide control may be used to keep the profile relatively low, while still providing for ease of cursor movement and control.

In this embodiment, the thumb control (34) may include well known spring loading means to automatically return to a central null position when not restrained by the user. As such, if the user lifts his or her thumb from the slide control (34), the slide (34) will automatically “self-center” or return to the middle of its travel in the two sliding dimensions.

If the device utilizes pressure sensing means (46), which is preferred, then the absence of thumb pressure may be used to interrupt the motion signal of the slide control, such that the self-centering motion does not yield any unintended cursor motion. One alternative, that may be especially attractive if pressure sensing means are not included, is to have the thumb operated slide control constructed with elasticity to yield slightly under pressure and rebound when the thumb pressure is removed. In that case, the slide control's motion control signal may be advantageously disabled when the slide is in the rebounded position, which offers an alternative method for ensuring that the slide's self-centering motion does not yield cursor motion.

It should also be noted that grip- or thumb-pressure sensitivity may be used for automatic cursor speed control. For the purposes of example, with light thumb pressure on the slide, the cursor speed setting may be very high, with a small slide motion yielding a relatively large cursor motion. Conversely, as pressure increases to a high level, the cursor speed setting may be reduced such that the slide motion generates a smaller cursor motion, for precision and fine position adjustments.

In general, regarding the size of the device, the grip itself is of a substantially minimum size such that the same can be gripped in a secure manner. As such, the grip provides a firm base for the plurality of buttons (24, 26, and/or 28), as well as the aforementioned trackball (30) or an alternative thumb-slide mechanism (34). Regarding such compact size, for the purposes of example only, the grip may be no more than one-half inch in thickness and may further be truncated at its top end (20) and butt end (22) so as not to extend beyond the user's hand to any significant degree.

Grip thickness in the vicinity of the thumb control is preferably not more than 1 inch, and still preferably less than about ¾ inches, the smaller thickness being particularly preferred if the thumb control is a slide control (34), for ease of manipulation. In this context, grip thickness is the horizontal dimension across the grip between the two side surfaces (16 and 18), and it can vary over the grip's length as illustrated in FIG. 5. in the preferred mode of production, the thickness of the grip does not exceed 1¼ inches at any portion over the active length of the grip. In this context, the active length is the portion of the grip's overall length that is actually grasped within the hand of the user when the pistol grip is held in the intended fashion.

Likewise, the width of the grip at the location of the thumb control is preferably not more than 2 inches. The width of the grip is the front-to-rear dimension, between surfaces (12) and (14), at any position along the length from top end to butt end. It should also be noted that the width of the grip may vary over the length of the grip, and may be at least ¼ inch wider at its butt end than at the location of the thumb control.

Next, as briefly noted above, in an enhanced embodiment of the present invention, the device further comprises a restraint means (36) such that the grip can be affixed to the hand of the user and worn thereby, as shown in FIGS. 6 and 9. This additional departure from the prior art functions to allow the user to release the device to attend to additional manual functions, especially computer keyboard operations, while the restraint means (36) holds the grip in place in the palm of the hand but leave the user's fingers unimpeded to perform those additional functions. Thus, this embodiment of the device uniquely allows the user to access a traditional computer keyboard in the manner depicted in FIGS. 6 and 9, without having to repeatedly discard and retrieve the pointing device.

In this embodiment the thumb-operated slide control is preferred over the track ball due to its lower profile, because the slide control has a lower profile leading to less likelihood of becoming an interference when the operator's attention is directed to keyboard use rather than cursor control. If a trackball is used, it should be a small one, preferably not more than about ⅞ inches diameter, and further preferably only about ¾ inches diameter.

Importantly, this ergonomically-shaped pistol grip input device is reduced in size, rendering the same unobtrusive when held against the user's palm. Grip thickness should not exceed ¾ inch, and preferably should be no more than about ½ inch. However we have found that too low a profile, while important to avoid interfering with keyboard use, makes the cursor motion control more difficult. Therefore overall device thickness, including the slide control, should preferably be at least about ¼ inch. The grip should be truncated at top and bottom so that it does not extend significantly beyond the operator's hand when held. This constraint, also, is to minimize interference when the operator is not using the invention for cursor control or other mouse related functions, but is wearing it while attending to other tasks such as keyboard functions. The restraint means (36) may be a simple strap as illustrated in FIG. 6. Alternatively it may be a brace or harness device from the wrist or forearm of the user, for example, as illustrated in FIG. 9.

In any such case, when the user's hand is open, such as while using the keyboard, the grip is held against the palm by the restraint means (36), which may comprise elastic properties extending around the hand from the top end to the bottom end of the grip.

Restraint means utilized in this manner, to hold the pistol grip module against the palm, can also be advantageously used to hold a second module (38) against the back of the hand, wrist, or forearm, as in the example of FIG. 6. In the preferred embodiment of this version, the second module (38) contains a data link transmitter (48), such as an infrared emitter in the example illustrated in FIGS. 6, 7, and 8, to transmit cursor control data to the computer.

With an infared source looking forward from the second module (38), it will be necessary for the user's arm to point in the general direction of the computer to complete the link. It must be noted that second module (38) also makes the cordless infrared data link option substantially easier to implement, as it offers an unobstructed field of view.

The data link transmitter (48) of module (38) may also be, for example, an RF transmitter if the requirement for line-of-sight transmission is inconvenient. In that case, however, the transmitter may be located within the pistol grip (10) if desired, since the requirement for line of sight is removed.

FIG. 9 illustrates another preferred embodiment in which the restraint (36) securing the grip is a brace or harness device from the wrist or forearm of the user.

As best depicted in FIG. 9, the restraint (36) may comprise multiple sections (40A, 40B, 42), which may include rigid, flexible, or even elastic components. It may also secure second module (38), which may house optical data link (48) facing forward towards the computer. In that case restraint means (36) functions not only mechanically, to hold the assembly together and in place upon the user's hand and/or arm, but may further function to provide support for electrical connections, between the grip (10) and second module (38). for example, wires may be coiled and supported on or in the elastic straps of FIG. 6, or in the structure of the brace of FIG. 9.

It is especially important to note that the second module (38) may further comprise related circuitry and/or at least one battery therein. Thus, all available space is utilized by the device in the most efficient way possible, providing the benefits of a further minimized device for the user.

If the device exemplified by FIG. 6 or 9 is made cordless, which is preferable, then it will require batteries. Due to space considerations, relatively small batteries are the preferred power means, thus rechargeable batteries may be effectively utilized.

Importantly, the restraint means (36) and associated module (38) may further be removable, such that the same can be placed upon either side with respect to the pistol grip (10), rendering the same effective for right-handed and left-handed users. In such instance, the front of module (38) remains in a front position, with reversal accomplished, for example, via folding of the straps of restraint (36) to the right instead of left or vice versa. This in turn allows forward looking infrared emitter (48) to remain in the required forward looking position.

Therefore, in total, the present invention consists of multiple embodiments, each representing a radical departure from the computer input devices common to the prior art. Both the first-above described pistol grip mouse and smaller user-worn version provide precision control, a great degree of user comfort, and significant conservation of workstation desk space previously unattained. In summation, the concept of the present invention is considered a vast improvement over the prior art, and various alternative embodiments capitalizing upon such concept have described and illustrated herein.

Thus, with regards to all descriptions and graphics, while the invention has been illustrated and described as embodied, it is not intended to be limited to the details shown, since it will be understood that various omissions, modifications, substitutions and changes in the forms and details of the device illustrated and in its operation can be made by those skilled in the art without departing in any way from the spirit of the invention.

Without further analysis, the foregoing will so fully reveal the gist of the present invention that others can readily adapt it for various applications without omitting features that, from the standpoint of prior art, constitute essential characteristics of the generic or specific aspects of this invention. What is claimed as new and desired to be protected by Letters Patent is set forth in the appended claims.

What is claimed is:

1. A hand-held pistol-grip input device, comprising:
a pistol grip handle, which comprises a forward surface, rear surface, left side, right side, upper end, and butt end,
a thumb-operated cursor control means located upon a surface of the input device, the cursor control means functioning to allow a thumb of an operator to rest thereon as the pistol-grip input device is hand-held by the user.

2. The pistol-grip input device as described in claim 1, wherein at least 2 buttons are located upon a surface of the input device and emulate functions of left and right buttons of a conventional computer mouse.

3. The pistol-grip input device as described in claim 2, wherein a first button functions as a first trigger engaged by an index finger of the user.

4. The pistol-grip input device as described in claim 3, wherein a second button functions as a second trigger engaged by a middle finger of the user.

5. The pistol-grip input device as described in claim 2, wherein the device further comprises a latching means, such that, when engaged by the user, the device produces a signal corresponding to a left mouse button in depressed position, while a corresponding button is not held down by the user.

6. The pistol-grip input device as described in claim 5, wherein the device further comprises a thumb control in a reversible cartridge such that the device can be held and operated in a right hand or a left hand of the user, with the thumb control on the left side or the right side of the device.

7. The pistol-grip input device as described in claim 5, wherein the device further comprises a pressure sensor means which functions to monitor thumb pressure on the thumb control and produce a signal used to modify a proportional relationship between the thumb control motion and resulting cursor motion.

8. The pistol-grip input device as described in claim 5, wherein the thickness of the side of the grip upon which the thumb control is located is not more than 1 inch.

9. The pistol-grip input device as described in claim 8, wherein the thickness of the grip does not exceed ¼ inches at any portion over the active length of the grip.

10. The pistol-grip input device as described in claim 5, wherein the thickness of the side of the grip upon which the thumb control is located is not more than ¾ inches.

11. The pistol-grip input device as described in claim 5, wherein the width of the grip at the location of the thumb control is not more than 2 inches.

12. The pistol-grip input device as described in claim 11, wherein where the width of the grip varies over the length of the grip, and is at least ¼″ wider at its butt end than at the location of the thumb control.

13. The pistol-grip input device as described in claim 5, wherein the thumb control is frictionally constrained such that a threshold force is required for the user to move the thumb control and move a cursor controlled thereby.

14. The pistol-grip input device as described in claim 13, wherein the threshold force required to move the thumb control is substantially the same as a force required to continue motion thereof.

15. The pistol-grip input device as described claim 14, wherein the thumb control and grip are so disposed that when the device is held between the thumb and palm of the user, the thumb control may be operated over a full range of motion with the thumb held in a substantially straight position.

16. The pistol-grip input device as described in claim 15, wherein the thumb control is a thumb operated trackball.

17. The pistol-grip input device as described in claim 16, wherein the trackball does not exceed 2″ in diameter.

18. The pistol-grip input device as described in claim 17, wherein the trackball is at least 1″ in diameter.

19. The pistol-grip input device as described in claim 16, wherein the trackball protrudes from the side of the grip by a distance of at least approximately 25% of the diameter of the trackball.

20. The pistol-grip input device as described in claim 16, wherein a rearmost exposed surface of the trackball is not more than ⅛″ forward of the rear surface of the grip at the closest point thereof.

21. The pistol-grip input device as described in claim 16, wherein the latching function is engaged by a user momentarily pressing a latching actuator located upon the butt end of the grip.

22. The pistol-grip input device as described in claim 16, wherein the trackball protrudes from both left side and right side of the grip, so disposed to allow both left-handed and right-handed users to effectively operate the input device.

23. The pistol-grip input device as described in claim 22, wherein the device further comprises a means to reverse the relationship, between the direction of trackball rotation and the direction of resulting cursor motion, to allow for usage by left-handed and right-handed users.

24. The pistol-grip input device as described in claim 22, wherein the device further comprises a detachable cover which functions to cover the trackball on the side of the grip that is not functional for the purpose of thumb control, thereby covering the trackball on the right side if a right handed operator is using the grip, so that the trackball is exposed to the operator's thumb on the grip's left-side, or to cover the trackball on the grip's left side so that the trackball is exposed to the operator's thumb on the grip's right side when a left-handed operator is using the device.

25. The pistol-grip input device as described in claim 15, wherein the thumb control is a thumb operated slide mechanism that is captive on a side of the grip, the slide mechanism functioning to slide up and down and forward and backward with respect to the grip.

26. The pistol-grip input device as described in claim 25, wherein the thumb control is incorporates spring loading means to automatically return to a central null position when not restrained by the user.

27. The pistol-grip input device as described in claim 26, wherein the relationship between slide motion and cursor motion is enabled by depressing the slide under at least light thumb pressure, and the slide/cursor relationship is disabled when thumb pressure is removed, so that the slide's auto-return to a null position with no applied thumb pressure does not result in cursor motion.

28. The pistol-grip input device as described in claim 27, wherein a distance by which the slide is depressed under light pressure is less than ⅛ inch.

29. The pistol-grip input device as described in clain 27, wherein the total thickness of the grip including thumb control slide, does not exceed ¾ inch.

30. The pistol-grip input device as described in claim 29, wherein the thickness of the grip is not less than ¼ inch.

31. The pistol-grip input device as described in claim 29, wherein the overall length of the grip is substantially the same as its active length, such that neither the top end or butt end thereof extends substantially beyond the hand of the user.

32. The pistol-grip input device as described in claim 5, wherein the device further includes restraint means such that the grip can be affixed to the hand of the user and worn thereby, functioning to allow the user to release the device to attend to additional manual functions while the restraint means holds the grip in place in the palm of the hand of the user while leaving the user's fingers unimpeded to attend to said additional functions.

33. The pistol-grip input device as described in claim 32, wherein the device comprises a first module and further comprises a second module affixed to the restraint means, the second module located on the restraint means upon the back of the hand, wrist, or forearm of the user when the device is worn by the user with the grip in the palm of the hand, the device cordless in nature with the second module comprising a communications means to convey control signals to a computer operated by the user.

34. The pistol-grip input device as described in claim 33, wherein the communications means comprises an infrared link and associated signal processing means.

35. The pistol-grip input device as described in claim 32, wherein the latching function is engaged by the user momentarily engaging a latching actuator located substantially upon the butt end of the device.

36. A hand-held computer cursor pointing device comprising: at least 2 buttons that emulate functions of left and right buttons of a conventional computer mouse, and further comprising a latching means, such that, when engaged by the user, the device produces a signal corresponding to a left mouse button in depressed position, while a corresponding button is not held down by the user.

37. A hand-held computer cursor pointing device comprising: a pistol grip held by restraint means against the palm of an operator's hand, said pistol grip including at least 2 buttons that emulate functions of the left and right buttons of a conventional computer mouse and further including means to control cursor movement, said pistol grip and restraint being so disposed to leave the user's fingers unimpeded to attend to keyboard tasks when not performing mouse-related functions.
